(19) United States
(12) Patent Application Publication
(10) Pub. No.: US 2021/0409575 A1
(43) Pub. Date: Dec. 30, 2021

(54) Electronic Clapperboard

(71) Applicant: Film Tools Ltd, Woodley (GB)

(72) Inventor: David Paul Gregory, Reading (GB)

(21) Appl. No.: 17/349,972

(22) Filed: Jun. 17, 2021

(30) Foreign Application Priority Data
Jun. 30, 2020 (GB) 2010020.2

(51) Int. Cl. H04N 5/06; H04W 76/10; G06F 3/14; H04N 5/77; G11B 27/34; G01J 1/42; G01C 9/02

(52) U.S. Cl. CPC H04N 5/06; H04W 76/10; G06F 3/1423; G06F 3/041; G11B 27/34; G01J 1/4204; G01C 9/02; H04N 5/77

(57) ABSTRACT

An electronic clapperboard is provided for use in film, television and video production processes. The electronic clapperboard comprising a clapper and a slate, and the clapper is disposed at the top of the slate and comprises an elongate member pivotally attached to the slate, and the slate defines a housing and comprises a manual display area and a plurality of electronic display areas disposed on the front surface, and an electronic rear display area disposed on the rear surface.

### FIELD

The present invention relates to a clapperboard for use in film, television and video production processes and in particular, to an electronic clapperboard.

### BACKGROUND

Clapperboards are a key component in the process of film, television and video production. Clapperboards are used as an audio and visual means to designate and mark the various scenes and takes, as they are filmed. This enables filmmakers to synchronise picture and sound in the post-production process.

At the start of a shot, the clapperboard is placed in view of a camera and produces a sound when a clapper arm is raised and released to hit the board. As well as producing a sound, recording the moment at which the clapper arm contacts the board also provides a visual queue by which to synchronise audio and visual components. The front surface of the clapperboard provides further visual means by which to identify what is being filmed, by displaying to the camera information items, such as scene, shot, take, and roll.

Using a manual clapperboard requires manual writing, removing and re-writing data onto the board itself. In addition to being time consuming and labour intensive, the manual tracking of these data is also prone to error as it relies upon the script supervisor to keep track of progress. Hand-written text can also be difficult to read and capture by the camera, especially during scenes shot in low light conditions, or those which employ effects, such as smoke. When filming outside, weather conditions (e.g. wind, moisture and light) can also have a similar detrimental effect on legibility. Accordingly, there is a need to improve this manual process.

### SUMMARY OF THE INVENTION

According to an aspect of the invention, there is provided an electronic clapperboard comprising a clapper and a slate, and the clapper is disposed at the top of the slate and comprises an elongate member pivotally attached to the slate, and the slate defines a housing and comprises a manual display area and a plurality of electronic display areas disposed on the front surface, and an electronic rear display area disposed on the rear surface.

The electronic clapperboard so constructed provides improved functionality and ease of use to that provided by manual clapperboards. It is advantageous as it replaces the manual process with electronic tracking and display, which reduces the time required to manage this data to a minimum. It is also beneficial as it removes any human error which may occur in tracking data. It also enables real-time data adjustments as the board is in use. Nevertheless, the provision of a manual display area in combination with an electronic display area is advantageous as it provides a means by which temporary, unusual or last minute data can be additionally added to the clapperboard.

The plurality of electronic display areas disposed on the front surface may include a first display area configured to toggle or switch between two different display configurations, each configured to display information relating to film production. Optionally, a first configuration may display a combination of one or more of Roll, Scene, Shot and Take values, and a second configuration may display a timecode.

The plurality of electronic display areas disposed on the front surface may include a second display area configured to display information relating to film production. Optionally, the information may include one or more of: date, time, audio recorder file number, Roll number, filter, frame rate, and lens focal length.

The provision of multiple electronic displays is advantageous as it enables the scene, shot, take and/or timecode to be displayed along with other pertinent information to the production process. The use of bright visual displays on the front of the board is also beneficial as it improves the clarity and visibility of the data when presented to the camera and viewed by the editor during post-production processing.

Similarly, an electronic rear display area improves the functionality of the clapperboard by providing further data input and display functions. In particular, being located at the rear of the clapperboard, enables the operator also positioned at the rear of the clapperboard to know and modify the information displayed on the front, without turning the clapperboard. This improves operability and efficiency in setting up a shot.

The electronic clapperboard may also include one or more individual LEDs disposed on the front surface of the slate. The one or more individual LEDs may correspond to a setting. Optionally, the setting may include one or more of Night, Day, Interior, Exterior, MOS, Camera A, Camera B, VFX, and Sync. The provision of these separate LED pixels extends the functionality of the clapperboard, yet are more power efficient than having the information on a display, thus extending battery life.

The electronic clapperboard may also include at least one label disposed on the front surface of the slate. Optionally, the at least one label is configured to display one or more headings corresponding to the information displayed in the first display area.

The at least one label may be configured to be inserted into and removed from a slot provided in the front surface of the slate to be detachable from the slate. Optionally, the at least one label is an electronic label encoded with heading information and configured to cause the first display area to display information corresponding to the heading information.

The provision of interchangeable labels is advantageous as it provides functionality that permits different elements (e.g. roll, scene, shot, numbers, letters) to be shown on the display, and in what order, by changing the position and/or encoding of the labels above the first electronic display area. This is beneficial when using the clapperboard in different countries, with different production companies or for different films, each of which may have different requirements for what is to be shown on the display. Accordingly, the clapperboard construction enables the display configuration to be adapted efficiently.

The electronic clapperboard may also include a light level sensor disposed on the front surface of the slate. This is beneficial to ensure that the electronic display areas are of sufficient brightness that they can be captured by the camera, but not too bright so as to be over exposed and also to be power efficient.

The rear display area may be an LCD display and at least part of the LCD display may comprise a touchscreen. This is advantageous as it enables the configuration of the clapperboard to be modified more easily. It also allows the operator the read aloud the configuration without having to turn the clapperboard away from the camera and remember the configuration. This is beneficial because reading out the configuration aloud is an essential part of the process so that the audio recording also contains the configuration of the current shot.

The electronic clapperboard may also include an operation panel disposed on the rear surface of the slate. Optionally, the operation panel comprises a plurality of input transducers.

The provision of one or more operation panels is advantageous as they provide the operator with input functionality without having to turn the clapperboard away from the direction of the camera. Accordingly, the operation panel enables the information shown on the front of the clapperboard to be changed as simply, efficiently and quietly as possible. This keeps the time taken to do so to a minimum and ensuring minimal disturbance on set. In addition, the provision of operation panels that are recessively formed is advantageous as it can stop the accidental trigger of inputs by the operator. Furthermore, tactile buttons can be quicker to operate than a touch screen, thus increasing time efficiency. Also having the buttons on the back, doesn't take up unnecessary space on the front of the clapperboard, leaving room for larger electronic and manual display areas.

The rear display area and/or the operation panel may be configured to control the operation of at least one of the plurality of electronic display areas. This is beneficial as it enables the operator to determine what is shown on the front of the clapperboard without having to turn the clapperboard away from the direction of the camera and disturb the production process.

The elongate member may comprise a lower member coupled to the slate and an upper member pivotally coupled to the lower member, and the upper member is movable between a first configuration in which a bottom side of the upper member is spaced apart from the lower member and a second configuration in which the bottom surface of upper member is disposed adjacent to the top surface of the lower member.

The elongate member may include a sensor configured to sense when the upper member moves between the first configuration to the second configuration. Optionally, when the upper member moves from the second configuration to the first configuration, a value displayed on one or more of the plurality of electronic display areas and/or the rear display area is automatically incremented by one. Additionally or alternatively, when the upper member moves from the first configuration to the second configuration, a record of values is stored in a memory of the clapperboard.

The advantage of storing the data according to this configuration is that the provision of a more accurate record of the shots than that normally recorded by the script supervisor. The other advantage is that these data can be used later in post-production software to help the editor identify shots more efficiently.

The electronic clapperboard may also include a timecode unit including a timecode generator configured to generate timecode and a timecode decoder, configured to receive and decode timecode from a master device and synchronise the timecode of the clapperboard with the master device. Optionally, the timecode generator is further configured to transmit timecode to an external device to synchronise timecode of the external device with the timecode of the clapperboard.

The electronic clapperboard may also include a tilt sensor configured to detect an orientation of the clapperboard.

The electronic clapperboard may be configured so that when the tilt sensor detects that the clapperboard is orientated face-down, the tilt sensor is configured to output a signal representing a first standby mode in which the plurality of electronic display areas, the individual LEDs and the light sensor are configured to turn off. Additionally or alternatively, when the tilt sensor detects that the clapperboard is orientated back-down, the tilt sensor is configured to output a signal representing a second standby mode in which the plurality of electronic display areas, the individual LEDs, the light sensor, and the rear display area are configured to turn off. Further additionally or alternatively, when the tilt sensor detects that the clapperboard is in an upright orientation, the tilt sensor is configured to output a signal representing an active mode in which none of the components are in a standby mode. This improves the power saving capability of the clapperboard, thereby extending battery life of the clapperboard.

The electronic clapperboard may be configured so that when the tilt sensor detects that the clapperboard is orientated upside-down, the tilt sensor is configured to output a signal representing an inverted mode in which the plurality of electronic display areas is configured to invert the information displayed on each display. This improves the functionality of the clapperboard, as display information is always orientated so that it can be readily understood.

The electronic clapperboard may also include a communication unit configured to connect to and transmit and/or receive information to/from an external device wirelessly. The communication unit may be configured to communicate over at least one of a WiFi network, a Bluetooth network, a near-field communication network, and an ISM band.

The communication unit may be configured to connect to an on-set camera; and transmit data stored in a memory at the clapperboard to an on-set camera to be included in metadata of the on-set camera. Additionally or alternatively the communication unit may be configured to receive data from the camera; and store the received data in a memory.

This construction improves the functionality of the clapperboard as transmitting data to the camera allows the camera to store that data in metadata of the video file. This, in turn, makes these data available in the post-production process, thereby making it easier and more efficient to identify which video files pertain to which shots.

The communication unit may be configured to connect to a mobile device, the mobile device including computer code that when executed by the mobile device causes the mobile device to transmit data to and/or receive data from the clapperboard. The computer code may comprise a discrete software application. Optionally, the mobile device is a smartphone or a tablet.

The communication unit may be configured to transmit data stored at the clapperboard to a website. The communication unit may be configured to transmit data to the website when the upper member of the clapper moves from the first configuration to the second configuration.

This configuration improves the efficiency of post-production processing. The ability to transmit data in real time as the shoot progresses, is advantageous as it improves production efficiency by enabling the progress of the shoot to be monitored during the day by off-set members of the crew. In turn, the schedule for following days and associated clapperboard settings can be adjusted, as necessary.

According to another aspect of the invention, there is provided a system comprising an electronic clapperboard according to embodiments described herein; and an external device, and the electronic clapperboard is configured to connect to and transmit and/or receive data to/from the external device wirelessly.

### BRIEF DESCRIPTION OF DRAWINGS

Embodiments will now be described, by way of example only, with reference to the following figures in which:

FIG. 1 is a perspective front view of embodiments of the clapperboard looking downwards from above.

FIG. 2 is a perspective view showing the front and side of embodiments of the clapperboard.

FIG. 3 is a perspective view showing the rear and side of embodiments of the clapperboard.

FIG. 4 is a schematic diagram showing components of embodiments of the clapperboard.

FIG. 5 is a schematic diagram showing the connectivity of embodiments of the clapperboard in a networked environment.

FIG. 6 is a perspective view showing the front and side of other embodiments of the clapperboard.

FIG. 7 is a perspective view showing the front and side of other embodiments of the clapperboard.

FIG. 8 is a perspective view showing the rear and side of other embodiments of the clapperboard.

FIG. 9 is a perspective view showing the front and side of other embodiments of the clapperboard.

### DETAILED DESCRIPTION

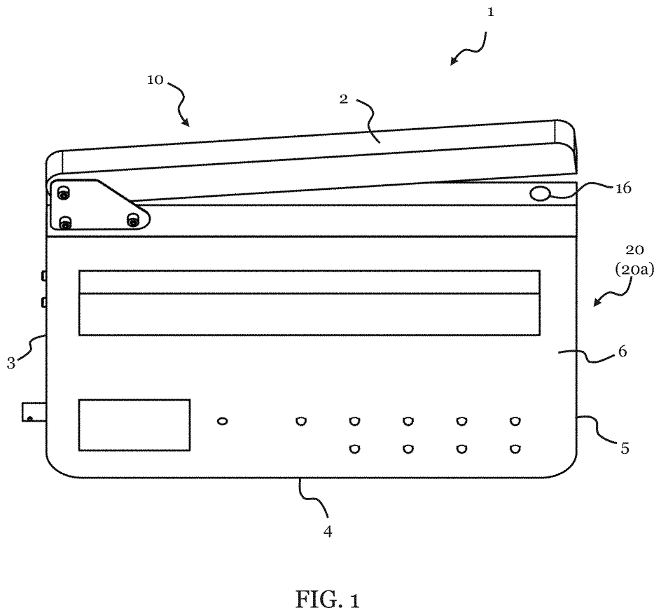

FIGS. 1 to 3 show embodiments in which an electronic clapperboard 1 comprises a clapper 10 and a slate 20. When viewed from the perspective of the camera, to which the clapperboard 1 is directed and in view of, the clapperboard 1 as a whole (clapper 10 and slate 20) has a top 2, a bottom 4, a left side 3, a right side 5, a front 6 and a rear 7. These elements may equally well be referred to as sides, surfaces or faces, interchangeably. The clapperboard 1 is of a standard size and standard arrangement with the clapper 10 disposed above the slate 20. The dimensions of the width and depth of the clapper 10 correspond to the width and depth of the slate 20, so that the clapper 10 and slate 20 form a uniform clapperboard 1.

Various components of the clapperboard 1 will now be described. The components described are non-exhaustive and in embodiments some components may be omitted and other components may equally well incorporated in the clapperboard 1.

FIGS. 1 to 3 show embodiments in which the clapper 10 is disposed on top of the slate 20. The clapper 10 forms an elongate member that is pivotally attached to the slate 20. The elongate member is formed from a pair of elongate members or clapsticks 12, 13. The clapper m includes a pair of clapsticks 12, 13 pivotally attached to the slate 20. The pair of clapsticks 12, 13 are joined by a hinge 14. The clapper m is, for instance, a hinged wooden clapper.

One of the pair of clapsticks 12, 13, forms the upper clapstick 12 (or first clapstick or upper member). The other one of the pair of clapsticks 12, 13 forms the lower clapstick 13 (or second clapstick or lower member) that is coupled to the top (upper surface) of the slate 20. The lower clapstick 13 may be viewed as an extension of the slate 20. Thus, the lower clapstick 13 may be integrally formed with the slate 20. The upper clapstick 12 is coupled to, and able to pivot relative to, the lower clapstick 13 by the operation of the hinge 14. The upper clapstick 12 is arranged to move between a first position (or configuration) in which the upper clapstick 12 is spaced apart from the lower clapstick 13 and a second position (or configuration) in which the upper clapstick 12 is adjacent to the lower clapstick. In the first position, the bottom surface of the upper clapstick 12 is spaced apart from the top surface of the lower clapstick 13 and in the second position, the bottom surface of the upper clapstick 12 is adjacent to the top surface of the lower clapstick 13. For instance, when the upper clapstick 12 is adjacent to the lower clapstick 13, it is in contact with the lower clapstick 13. When the upper clapstick 12 is raised and released at the start of a shot, in that it moves from the second position to the first position and back to the second position (under the influence of gravity), this is known as the ‘point of clapping’. In other words, the ‘point of clapping’ is when the upper clapstick 12 returns to the second position, having been in the first position.

The pair of clapsticks 12, 13 may include a biasing means configured to bias the upper clapper 12 in either the first position or the second position. Typically, the pair of clapsticks 12, 13 are biased in the second position. The biasing means may be of any suitable type, for instance, magnetic. FIGS. 1 to 3 show embodiments in which each of the pair of clapsticks 12, 13 includes a magnet. The magnets (not shown) are embedded in opposing faces of the respective ones of the clapsticks 12, 13 and located to correspond with each other. Each magnet has the opposite polarity to the other so that the pair of clapsticks 12, 13 remain closed (i.e. paired together in the second position) when not in use, due to the force of attraction between the magnets.

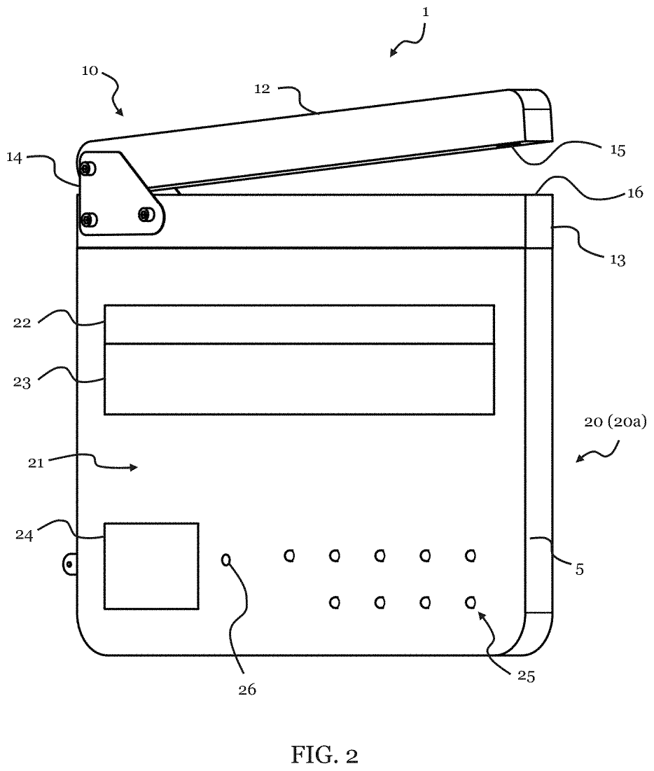

In addition, the clapper 10 includes a sensor capable of detecting when the upper clapstick 12 moves between positions. That is to say, when the upper clapstick moves from the first position to the second position and/or from the second position to the first position. The sensor may be any suitable type to detect movement of the clapper 10. For instance, one of the pair of clapsticks 12, 13 includes a switch 16. The switch 16 may be any suitable kind of electromagnetic switch. In particular, the switch is a reed switch 16. The other one of the pair of clapsticks 12, 13 includes a second magnet 15. The second magnet 15 may be any suitable type of magnet to function in combination with the reed switch 16. The reed switch 16 and the second magnet 15 are embedded into opposing faces of the respective ones of the clapsticks 12, 13 to correspond with each other. The reed switch 16 and the second magnet 15 are located so as not to interfere with the magnets used to bias the clapsticks 12, 13 closed (in the second position), when not in use. FIGS. 1 and 2 show embodiments in which the upper clapstick 12 includes the second magnet 15 and the lower clapstick 13 includes the reed switch 16. However, this is not essential and the opposite arrangement may equally well be provided.

FIGS. 1 to 3 show embodiments of the arrangement of the slate 20. The slate 20 has a body 20a that defines a housing. The slate body 20a is configured to house or accommodate various components of the clapperboard 1. These components may be provided inside the slate body 20a, outside the slate body 20a or a combination of both. FIGS. 1 to 3 show the hardware components visible on the exterior of the slate body 20a. The slate body 20a is formed from plastic. Any suitable plastic may be used to provide a robust, weather proof, yet lightweight body.

FIGS. 1 and 2 show embodiments in which the front 6 of the slate 20 includes a manual display area 21 and a plurality of electronic display areas 23, 24 (or front display areas). One or more individual light sources 25 are located on the front 6 of the slate 20, each representing an individual point source of light that is a separate component to the plurality of electronic display areas 23, 24. The front 6 of the slate 20 also includes at least one label 22. A light level sensor 26 is also disposed on the front 6 of the slate 20.

The manual display area 21 represents those areas of the front surface 6 of the slate 20 that are not occupied by electronic components. The manual display area 21 provides a surface on which information can be removably written. In that, it is a surface on which information can be written by hand with a suitable writing implement, and can be erased and replaced, as appropriate. Those areas of the front surface 6 that are not occupied by electronic components provide a wipeable surface, allowing an operator to write on and remove text from that surface. The manual display area 21 is formed from plastic or any suitable a material on which information can be repeatedly written and removed. The manual display area 21 may display information that is unlikely to change during the filming process, although it is not limited to this. This information may include, for instance, the production, the director, and the camera person. As such, the information only needs to be written on the slate 20 once at the start of production, minimising the process of manual writing. The manual display area 21 may also include one-off pieces of information that are specific to a particular shot, scene or day and only need to be included once during production.

The plurality of electronic display areas 23, 24, includes a first display area 23 and a second display area 24. The first display area 23 is able to display information relating to the production process. The first display area 23 has a substantially rectangular shape, extending across an approximately central portion of the front surface 6. The first display area 23 is a matrix display and more particularly, an LED matrix display. The matrix display may be a 64×8 matrix. The LED matrix display is comprised of a plurality of green LEDs, although it is not limited to this. The brightness of the LEDs can be varied.

The first display area 23 can be switched or toggled between two different display configurations or formats. The first configuration of the first display area 23 includes displaying a combination of one or more of Roll, Scene, Shot and Take values. Scene/Shot values can also be grouped together for display. One or more of these values can be displayed in any order on the first display area 23. The Roll value is an alphanumeric value in the format of camera letter designation, followed by a 3-digit numeric value from 1 to 999. The value may be padded with zeroes for numbers less than 100. For example, A001, where ‘A’ represents the camera identifier and ‘001’ represents the roll number for that camera. The Scene value is a 3-digit numeric value from 1 to 999. The value may be padded with zeroes for numbers less than 100. The Shot value is displayed in one of two formats. The first format is a 3-digit numeric value from 1 to 999. The value may be padded with zeroes for numbers less than 100. The second format is an alpha value, including up to two letters of the alphabet. In the case of alphabetical data, once Z has been reached, the value displayed will move to a two-character system, starting with A (e.g. AA). Letters that are hard to distinguish from numbers, such as I and O, can be excluded from the character system. The Take value is a 2-digit numeric value from 1 to 99.

The second configuration of the first display area 23 is to display a timecode. The timecode is defined by the Society of Motion Picture and Television Engineers (SMPTE) and provides a time reference for post-production processing. The timecode input/output is a linear (LTC) SMTPE timecode.

FIGS. 1 and 2 show embodiments in which at least one label 22 is located above the first display area 23. The at least one label 22 is provided adjacent to the top of the first display area 23. The at least one label 22 may provide the heading (designation, tag, marker, or identifier) corresponding to the information displayed in the first display area 23. For instance, when the first display area 23 is set to the first configuration, the at least one label 22 may display headings, such as ‘Scene’, ‘Shot’, ‘Roll’ or a grouped heading, such as ‘Scene/Shot’. Alternatively, when the first display area 23 is set to the second configuration, the at least one label 22 may display the heading ‘Timecode’. The at least one label 22 may consist of only one label arranged to display all of the required information. For instance, one label may display the heading ‘Timecode’. Alternatively, the at least one label 22 may include more than one label, each arranged to display a heading or a grouped heading. For instance, the at least one label 22 may include two labels, where one label (a first label) displays the grouped heading ‘Scene/Shot’ and the other label (a second label) displays the heading ‘Roll’. Alternatively, the at least one label 22 may include three labels. For instance, each of the three labels displays a heading, such as one of ‘Scene’, ‘Shot’, and ‘Roll’. The at least one label 22 may also include more than three labels.

The at least one label 22 may take various forms, as well as varying in number. For instance, the at least one label 22 may form part of the manual display area 21, such that the required heading is manually written above the first display area 23. In other words, the at least one label 22 is an extension of the manual display area 21. Alternatively, rather than being manually written the at least one label 22 may include a heading that is printed or embossed on the front surface 6 of the slate 20. Alternatively, the at least one label 22 may be an electronic display, for instance an organic light-emitting diode (OLED) display. The OLED display can be any suitable OLED that is clear enough for a camera to see and record. Alternatively, the at least one label 22 may be a detachable element that can be inserted into and removed from a slot (not shown) formed in the slate body 20a by a suitable coupling means (not shown). According to some embodiments, the detachable element may be encoded. For instance, the at least one label 22 is encoded to inform the clapperboard 1 of the information displayed by the at least one label 22. For instance, when the at least one label 22 is a detachable element, heading information is provided (for instance, written, printed or embossed) on the front surface of the at least one label 22. The at least one label 22 may be encoded according to the heading information provided on the front surface of the at least one label 22. The detachable element may be encoded when removed from the slot and detached from the slate body 20a. When the at least one label 22 is inserted into the respective slot in the slate body 20a, it causes the first display area 23 to display a value corresponding to the heading information associated with that at least one label 22. It will be understood that different combinations of forms of the at least one label 22 could be implemented. For instance, the at least one label 22 may include three labels forming two OLED displays and one manual display area. Alternatively, the at least one label 22 may include two labels, forming one OLED display and one detachable element. Various other combinations may equally well be implemented.

The second display area 24 is a different type of electronic display to the first display area 23. The second display area 24 is an OLED display. The OLED display can be any suitable OLED that is clear enough for a camera to see. The brightness of the OLED display can be varied, independent of the brightness of the first display area 23. The second display area 24 may be located in a bottom corner region of the front 6 of the slate 20 and may have a substantially square shape, although the invention is not limited to this arrangement.

The second display area 24 is able to display a variety of information relating to the production process. The type and format of the information displayed can be input, selected and varied. This information includes, for instance, any one or more of: Date, either in UK DD/MM/YY format or US MM/DD/YY format; Time, in 24 hour HH:MM:SS format; Audio Recorder file number, as an integer from 0 to 9999, which may be padded with zeros for numbers less than moo to match the recorder; Roll number, in the alphanumeric format as described above in relation to the first display area 23; Filter, as a text string; Frames per second (frame rate), as a decimal value, and; Lens Focal Length, as an integer value.

FIGS. 1 and 2 show embodiments in which the one or more individual light sources 25 are in the form of light emitting diodes (LEDs). In the following, the one or more light sources 25 is described as a plurality of individual light sources or individual LEDs, but it is to be understood that one individual LED may equally well be provided. In other words, one or more individual LEDs 25 may be provided. The individual LEDs 25 may be located in a bottom corner region of the front 6 of the slate 20, although the invention is not limited to this. The individual LEDs 25 are a different component to the LED matrix of the first display area 23. The individual LEDs 25 represent one or a group of separate LEDs arranged to be spaced apart from each other. The LEDs could be any suitable type of LED that is clear enough to be seen by a camera in daylight. The individual LEDs 25 shown in FIGS. 1 and 2 emit green light, although the invention is not limited to this. The individual LEDs 25 are arranged in an array of rows and columns, although this is not essential.

The individual LEDs 25 are used to indicate conditions, settings or configuration options associated with the production process. The individual LEDs 25 indicate information based on whether or not each individual LED 25 is illuminated or not. Typically, when an LED is illuminated it indicates a positive confirmation of a condition and when an LED is not illuminated it indicates a negative confirmation of a condition. For instance, the state of illumination indicates whether a setting is on or off, whether ‘yes’ a condition is met or ‘no’ it is not, or whether ‘yes’ an on-set device is in use or ‘no’ it is not. However, the opposite configuration may equally well be used. Any number of the individual LEDs 25 (or none) can be employed, as required. Each individual LED 25 is allocated to a particular setting when in use. Any relevant setting may be associated with each individual LED 25. For instance, any one of: Night, Day, Interior, Exterior, MOS, Camera A, Camera B, VFX (visual effects), and Sync. As an example, the illumination of individual LEDs 25 associated with these settings can indicate that the filming is occurring outside (exterior), during the day and that visual effects will be added in post-production.

Each individual LED 25 may include a heading (not shown) to identify the setting that the individual LED 25 corresponds to. Each heading may be located adjacent to the respective individual LED 25. Each heading may be written on the manual display area 21 or pre-printed or embossed onto the slate body 20a.

FIGS. 1 and 2 show embodiments in which a light level sensor 26 is provided on the front surface 6 of the slate 20. The light level sensor 26 may be located between the second display area 24 and the individual LEDs 25, although this is not essential, and it may be provided at any location on the front 6 of the slate 20 where it does not interfere with the operation of the other components. The light level sensor 26 is configured to detect the level of light in the immediate environment around the clapperboard 1 and to output a value corresponding to the light level detected. This represents the level of light hitting the clapperboard 1, when the clapperboard 1 is in use on set and is typically facing the camera. This enables the clapperboard 1 to detect the light level on set and captured by the camera, which may be very different to the light level off set (for instance, behind the camera). The light level sensor 26 may be any type of sensor suitable for detecting light levels. For instance, a photoresistor or a phototransistor. The brightness level of the electronic display areas can be set automatically, based on the detected light level.

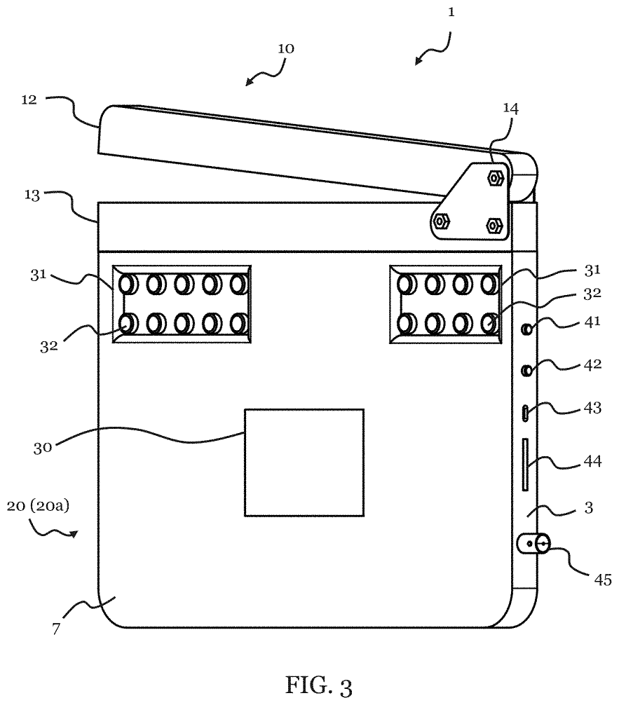

FIG. 3 shows the rear 7 and left side 3 of the clapperboard 1. The rear surface 7 of the slate 20 includes an electronic rear display area 30. The rear surface 7 also includes an operation panel, for instance, two operation panels 31.

FIG. 3 shows embodiments in which the rear display area 30 is an electronic display area (electronic display). The rear display area 30 is in the form of a liquid crystal display (LCD). The LCD may be any suitable LCD that is large enough and bright enough to be seen when the operator is holding the clapperboard 1 towards the camera, for instance a 4.2″ high resolution display. At least part of the LCD display includes a touchscreen. The touchscreen may be provided on all of the LCD display. FIG. 3 shows embodiments in which the rear display area 30 is a resistive or capacitive touchscreen LCD display.

The rear display area 30 is able to display the same information as that shown on the front 6 of the slate 20. In other words, the rear display area 30 shows the information displayed on the first and second display areas 23, 24. The rear display area 30 may also display the same information as that represented by the individual LEDs 25. It may also display the information written on the manual display area 21.

The rear display area 30 also displays various information relating to the operation of the clapperboard 1. For instance, the rear display area 30 may display a power level indicator to indicate the remaining battery power for the clapperboard 1. The power level indicator is in the form of a battery icon, for instance and may further include the numeric percentage of battery power remaining. The rear display area 30 may also display an icon to indicate an active communication connection, such as a wireless connection. For instance, a Bluetooth icon to indicate the presence of an active Bluetooth connection. The rear display area 30 may also display an icon to indicate whether removable memory is currently provided in the clapperboard 1. For instance, a memory card may be inserted into a memory card slot 44 provided at the side 3, 5 of the clapperboard 1.

In relation to the rear display area 30, the configuration of the clapperboard 1 is determined via the LCD display in combination with the touchscreen. The LCD display is configured to display one or more of menus, options, lists, icons, graphical user interfaces (GUIs) and a keyboard (e.g. numeric, alphabetical, alphanumeric), which can be navigated via the touchscreen in order to select, input, edit, confirm, or save data and settings.

For instance, the following data (amongst others) can be edited via the touchscreen: date and time, the fields displayed in the first display area 23 and/or the second display area 24, the brightness of electronic display areas 23, 24 or the individual LEDs 25, the time interval after which the clapperboard 1 will automatically go into a standby mode, and the data stored on the clapperboard 1. The configuration of the filter and frame rate can also be configured via the rear display area 30. This is done via the touchscreen by pressing on an onscreen value and selecting from a list, which can be edited. As most matte boxes accommodate two filters, the list of filters is displayed in two columns allowing the selection of two filters at a time. Filters may include different levels of neutral-density (ND) filter, a variable ND filter, a graduated ND filter, a polariser and a circular polariser. The list of frame rates includes the standard film and broadcast rates, for instance 23.98, 24, 25, 30.

FIG. 3 shows an embodiment in which the rear 7 of the slate 20 also includes two operation panels 31. The operation panels 31 may be provided in the upper area of the slate body 20a and spaced apart from each other. Each operation panel 31 includes a plurality of input transducers, buttons or switches, which can be used to trigger actions and/or confirm something.

FIG. 3 shows an embodiment in which each operation panel 31 includes a plurality of buttons 32. The operation panels 31 are recessed (recessively formed) in the slate body 20a so that the plurality of buttons 32 do not protrude above the rear surface 7 of the slate body 20a. The plurality of buttons 32 may be any sort of button suitable for sending a signal to a microcontroller. For instance, each of the plurality of buttons 32 is a momentary tactile push button switch.

In relation to the operation panel 31, the plurality of buttons 32 is manipulated by the operator to operate and configure the clapperboard 1. The plurality of buttons 32 can provide a variety of functionality in the clapperboard 1 by performing numerous operations. A different function can be applied to each of the plurality of buttons 32. The rear surface 7 of the clapperboard 1 may include labels or headings (not shown) associated with each of the plurality of buttons 32, to identify the function of that button. Each heading may be located adjacent to the respective button. For instance, each heading may be pre-printed or embossed onto the slate body 20a. The plurality of buttons 32 are configured to select, edit and set various settings of the clapperboard 1 and to confirm or cancel various operations. When one of the plurality of buttons 32 is pressed, a signal is sent to a microcontroller (described later), which interprets the signal and updates the electronic displays at the front 6 of the slate 20 and/or on the rear display area 30 based on the signal. Some of the buttons among the plurality of buttons 32 control what is displayed on the first display area 23 and the second display area 24. Other buttons among the plurality of buttons 32 change the configuration of the individual LEDs 25.

At least one of the plurality of buttons 32 is configured to toggle between settings. In other words, when the button is pressed, this causes a particular setting to switch between configurations. For instance, in response to a first push, a setting is switched from a first configuration to a second configuration and in response to a second (subsequent) push, that setting is switched from the second configuration back to the first configuration. As an example, the button can toggle an individual LED 25 between an on state and an off state. Alternatively or additionally, the button can toggle between two different individual LEDs 25 being in an on state and an off state. For instance, where one individual LED corresponds to ‘Interior’ (‘Int’) and another corresponds to ‘Exterior’ (‘Ext’), these are mutually exclusive settings, so that the button can toggle between either the individual LED corresponding to ‘Interior’ being in an on state and the individual LED corresponding to ‘Exterior’ being in an off state, or vice versa. Alternatively or additionally, the button can toggle the display of the first display area 23 between the first configuration and the second configuration.

In addition, two of the buttons amongst the plurality of buttons 32 are configured to operate in pairs. One of the two buttons is configured to incrementally increase a data item and the other of the two buttons is configured to incrementally decrease a data item. For instance, a pair of buttons is arranged to increase or decrease the numeric or alphanumeric data items corresponding to the Scene, Shot, Take, Roll, and Audio File number. An individual button press on one of the pair of buttons will increment (or decrement) the value by one, or in the case of alphabetical data will change the value to the next (or previous) sequential value (e.g. ‘A’ will change to ‘B’). An individual button press on the other of the pair of buttons with have the converse effect.

At least one of the plurality of buttons 32 is configured so that when the button is pressed and held in the down position, the speed at which the increment (or decrement) occurs will increase. This allows a greater change to be achieved more rapidly. When both up and down buttons are pressed together, the value will reset to the default value for that field (i.e. 1 if numeric, or ‘A’ if alphabetical).

Although the above functions are described with respect to the plurality of buttons 32 of the operation panels 31, they may equally well be performed via the touchscreen of the rear display area 30 or by a combination of the operation panels 31 and the rear display area 30.

For instance, the brightness of the electronic display areas can be modified and set via the operation panels 31 and/or the rear display area 30. This includes the brightness of the LED matrix display 23, the OLED display 24 and the LCD display 30. Modification of brightness can include inputting a specific value, selecting a value from a range of values and/or selecting a mode, such as an auto brightness mode, via a keypad, a menu or an icon (e.g. a slider) on the touchscreen of the rear display area 30 of the clapperboard 1. Alternatively, the brightness of the LED matrix display may be increased or decreased via a pair of the plurality of buttons 32 on the operation panels 31 and/or the auto brightness mode may be turned on/off by toggling one of the plurality of buttons 32. In the auto brightness mode, the brightness of each electronic display area is adjusted automatically based on the output (detected light level) from the light sensor 26. This ensures that each electronic display area is always bright enough, relative to the immediate surroundings, to be captured by the camera. Typically the clapperboard 1 is set in the auto brightness mode. However, manual brightness variation may equally well be implemented.

FIG. 3 also shows embodiments of the left side 3 of the clapperboard 1 where one or more additional components are provided. Various combinations of components can be provided on one or both sides 3, 5 and the base 4 of the clapperboard 1, such as input transducers, buttons or switches, which can be used to trigger actions and/or confirm something.

FIG. 3 shows a power button 41 via which the clapperboard 1 may be turned on and off. For instance, when a single push is received the clapperboard 1 is turned on, and when a press and hold for a predetermined number of seconds is received, the clapperboard 1 is turned off. This arrangement avoids any accidental switch off of the clapperboard 1 during operation. A standby button 42 is also provided via which the clapperboard 1 may be put into a standby or power-saving mode. The standby mode is configured so that power is turned off to all but the essential components of the clapperboard 1, to maintain a base level of operability. This represents a low power mode. So it is possible to temporarily switch off the electronic display areas, the individual LEDs 25 and some internal devices and put the clapperboard 1 into a low power standby mode, rather than operating in an active or full power mode or a power-off mode. The standby button 42 is arranged to switch power modes upon receiving a single press, both to enter standby mode and to resume full power. The buttons may take any suitable form.

Other input transducers may also be provided on the side 3, 5 of the clapperboard 1, such as a communications button to cause establishment of a connection to or a pairing with another device or to trigger transmission or receipt of information from the clapperboard 1 to an external device.

FIG. 3 shows embodiments in which the left side 3 of the clapperboard 1 also includes a USB input 43 (or port), a memory card slot 44, and a BNC connector 45. The USB input 43 enables connection to an external device via a USB cable. For instance, the USB input 43 enables charging of the clapperboard 1 and/or transfer of data stored at the clapperboard 1. The memory card slot 44 provides a point of connection and temporary accommodation for removable data storage. The BNC connector 45 enables timecode data transfer, both to and from an external device. The provision of a BNC connector is advantageous as it enables the timecode of the clapperboard to be readily synchronised with an external device.

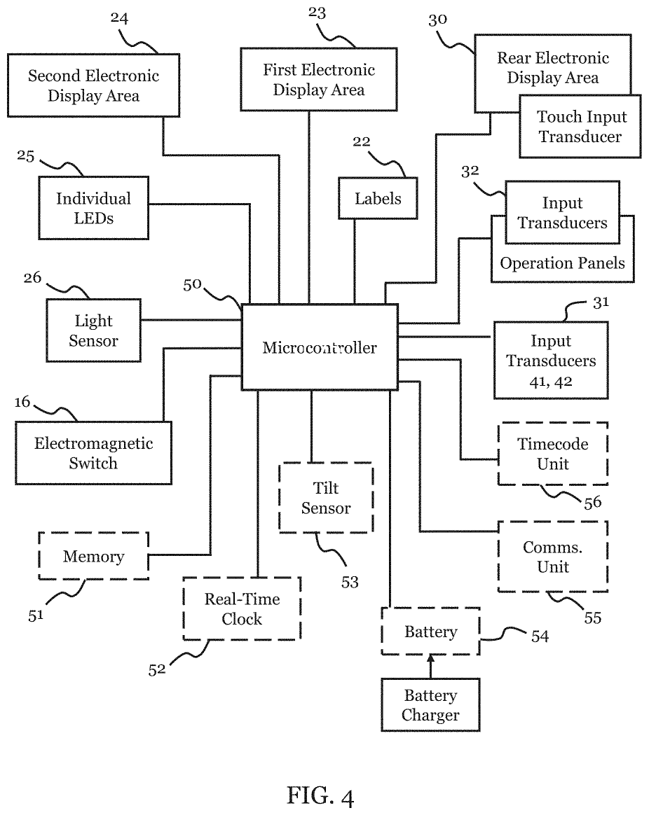

FIG. 4 shows a schematic diagram of some of the components of the clapperboard 1. Internal components of the clapperboard 1 are housed within the slate body 20a. The clapperboard 1 includes a processor or microcontroller 50 which controls operation of the components of the clapperboard 1. The microcontroller 50 could be any suitable microcontroller, for instance an ESP32 microcontroller or ARM based microcontroller. The microcontroller 50 and other hardware components may be connected via a system bus or more than one system bus. Each hardware component may be directly connected to the microcontroller 50 or connected to a multiplexor either directly or via an interface. The multiplexor could be any suitable multiplexor, such as an input multiplexor (for instance, a MCP23017) and an output multiplexor (for instance, a 74HC595).

FIG. 4 shows embodiments in which the internal components of the clapperboard 1 include: a memory 51, a real-time clock (RTC) 52, a tilt sensor 53, a battery 54, a communication unit 55, and a timecode unit 56.

The memory 51 includes a built-in memory and/or a removable memory. The built in memory may include a program memory, a Read-Only Memory (ROM), and an electrically erasable programmable read-only memory (EEPROM). FIG. 4 shows embodiments in which the built-in memory includes all three of these components, although that is not essential. In this case, the program memory is volatile and only used in the execution of program code. The program member may be random-access memory (RAM) and the microcontroller 51 may access RAM in order to process data and control storage of data. The RAM may be a RAM of any type, for example Static RAM or Dynamic RAM. The ROM stores the compiled program code. The EEPROM stores configuration data. Each time a setting is changed, for instance scene or brightness, the new setting configuration is stored in the EEPROM, so that these settings are maintained even when the clapperboard 1 is switched off. When the clapperboard 1 is switched on, settings are read from the EEPROM to configure the clapperboard 1 according to the stored settings.

The removable memory is non-volatile and may include a flash card, a microSD card, an SD card (e.g. SD, SDHC, SDXC), or the like. The removable memory may be temporarily accommodated in the slate body 20 via the memory card slot 44. Alternatively, the removable memory may be connected indirectly via the USB input 43, using a USB cable. The removable memory stores a log of information associated with the production process. For instance, the removable memory stores a log of information that is relevant to the post-production process. A new log is stored each time the clapper is clapped. The log may include the Scene, Shot, Take, associated date and time, and the like. Other data stored in the log may include timecode and individual LED settings such as Int/Ext, Day/Night, VFX, MOS, and the like. This is a non-exhaustive list and other data could equally well be stored. For instance, a record of the last Take for a Scene and Shot combination may be stored. Using these records, when the user returns to a previous Scene and Shot, the clapperboard 1 will show the last Take plus one. These data are stored in association with the current film being shot, as each film will have its own Takes for a Scene and Shot combination. The provision of an electronic memory is advantageous as it enables the clapperboard to store and edit data as the clapperboard is in use.

The RTC 52 is configured to keep track of the current time and is supported by a separate rechargeable battery backup to prevent failure. Power is always supplied to the RTC 52, even when the clapperboard 1 is switched off or in a standby mode. The RTC 52 may be any suitable device that can inform the microcontroller 50 of the current time and keep time when the clapperboard 1 is turned off. For instance, the RTC 52 is a DS3231.

The tilt sensor 53 is configured to determine the orientation of the clapperboard 1. For instance, the tilt sensor 53 detects whether the clapperboard 1 is orientated upright, face-down, or back-down and outputs a signal corresponding to each of these orientations. This signal is sent to the microcontroller 50 to inform it of the orientation of the clapperboard 1. The signal output by the tilt senor may be used to trigger various functions of the clapperboard 1. For instance, the output of the tilt sensor 53 may be used to initiate a power saving mode or a standby mode or to change the configuration of the electronic display areas. The tilt sensor 53 may be any suitable type of tilt sensor that can interface with the microcontroller 50. For instance, the tilt sensor 53 is an internal gyro and accelerometer, such as a MPU6050.

The internal battery 54 is a rechargeable battery. The battery is, for instance, charged via the USB input 43. A battery monitor (not shown) for the battery may also be included. The battery monitor could be any suitable battery charge sensing device that can interface with a microcontroller 50, such as a MAX17043.

The communication unit 55 enables the clapperboard 1 to connect to or pair with an external device. The microcontroller 50 controls the communication unit 55 to connect to and to transmit and/or receive information to/from another device in a wireless fashion. Transmission may, for instance, be based on radio transmission (e.g. via ISM radio bands) or wireless computer networks or optical transmission. The wireless network may include a Bluetooth network, a WiFi network, near-field communication network, or the like. For instance, the communication unit 55 is a Bluetooth, Bluetooth Low Energy or WiFi transceiver. The communication unit 55 may comprise WiFi, 3G, GPRS, or the like. Alternatively, the wireless communication unit 55 may be substituted or complemented by a wired unit configured to transmit and/or receive information to/from another device in a wire-bound fashion, for instance via a cable or fibre connection.

The timecode unit 56 controls the clapperboard 1 timecode. As the timecode may be subject to drift, it is important that the timecode is accurate and is monitored, updated and synchronised between devices regularly. In order to prevent drift and keep accurate time, the timecode unit 56 may use any suitable means. The timecode unit 56 may include a 10 MHz oscillator. The oscillator may be a temperature-compensated crystal oscillator.

FIG. 4 shows embodiments of the clapperboard 1 in which the timecode unit 56 includes a timecode decoder and a timecode generator (not shown). The timecode decoder and timecode generator enable, respectively, the clapperboard 1 to act as a slave device and master device. When the clapperboard 1 acts a slave device, the timecode decoder decodes the timecode received from the master device. In other words, the timecode decoder is configured to receive the industry standard LTC timecode and convert it to the relevant logic level to be processed and sent to the microcontroller 50. A timecode decoder includes, for instance, an appropriate LM358 and supporting circuitry. Alternatively, when the clapperboard 1 acts as a master device, the timecode generator generates the timecode against which all other devices are synchronised. The frame rate of the internal timecode generator is configurable. As the timecode unit 56 includes both the timecode decoder and the timecode generator the clapperboard 1 may act as either a slave device and/or a master device and is capable of interchanging between the two as required.

The clapperboard 1 may also include an Ingress Protection (IP) rating, to define the level of sealing effectiveness of the slate body 20a against intrusion from foreign bodies and moisture (e.g. dirt, sand, rain). The clapperboard 1 may have an IP rating that ensures it resists water ingress, for instance when the clapperboard 1 is used outdoors (‘Ext’) in the rain. The clapperboard 1 may have an IP rating of IP41 or IP44, for example.

Various operations of the clapperboard 1 will now be described. The operations described are non-exhaustive and other operations derived from the configuration of the clapperboard 1 are also envisaged.

The clapper 10 of the clapperboard 1 is operated to generate a sound at the start of a shot in order to synchronise film with audio in post-production processing. The upper clapstick 12 is raised and released to contact the lower clapstick 13 (under the influence of gravity) and thereby generate a sound, in the normal way. The sound is used in combination with the visible contact of the upper clapstick 12 on the lower clapstick 13 and the visual information displayed on the slate 20 and recorded by the camera, to synchronise the film and audio for a given take.

The clapper 10 is also configured to control at least some of the information displayed on the front 6 of the slate 20. For instance, the clapper 10 is configured to control the information displayed on the first display area 23. This is achieved via the switch and in particular, by the interaction between the magnet 15 and the reed switch 16 of the clapsticks 12, 13. The switch is configured to detect the movement of the upper clapstick between first and second configurations and to output a signal according to that movement. When the upper clapstick 12 has been raised and released at the start of a shot, it remains paired to (biased towards) the lower clapstick 13 due to contact between the magnets provided at the upper clapstick 12 and the lower clapstick 13. Subsequently, when the upper clapstick 12 is raised again, the Take value is automatically incremented by one. In other words, when the scene and the shot are the same (have not been changed), but a new take is required, then raising the upper clapstick 12 will automatically increment the Take value displayed in the first display area 23, and optionally in the rear display area 30, by one. If the MOS setting is not on, the audio file number displayed in the second display area 24, and optionally in the rear display area 30, will also automatically increment by one when the upper clapstick 12 is raised again. When the upper clapstick 12 has been raised and released at the start of a shot, the rear display area 30 is also configured to display an indicator, such as an icon, to inform the operator that any subsequent lifting of the upper clapstick 12 will increase the Take value.

In addition, each time the upper clapstick 12 is raised and released, the microcontroller 50 is configured to generate a record or log of all the settings pertaining to the current take and to store the record in the clapperboard 1 memory 51. For instance, the record is stored in the removable memory. When the upper clapstick 12 makes contact with the lower clapstick 13 at the point of clapping (it is in the second position), a new record is generated of all the settings pertaining to the new take. The rear display area 30 also displays an input option to allow the operator to input the rating for the previous take. The rear display area 30 can also display an input option to display a list of previous takes on the rear display area 30.

The clapperboard 1 is configured through the operation panels 31 and/or the touchscreen of the rear display area 30. In other words, the settings selected, the information displayed on the front 6 of the slate 20, and the information stored by the clapperboard 1 is controlled through the operation panels 31 and/or the touchscreen display. In particular, the format and/or type of information displayed on the first display area 23, the second display area 24 and the illumination state of the individual LEDs 25 is configured through the operation panels 31 and/or the touchscreen of the rear display area 30. Where the above functions are described with respect to the plurality of buttons 32 of the operation panels 31, they may equally well be performed via the rear display area 30, or by a combination of the operation panels 31 and the rear display area 30.

According to some embodiments, the configuration of the electronic display areas 23, 24 on the front 6 of the clapperboard 1 and/or the rear electronic display area 30 may also be controlled according to the output of the tilt sensor 53. For instance, in production it may be necessary for the operator to hold the clapperboard 1 upside down. This means that the clapperboard 1 is rotated from its normal orientation by approximately 180 degrees, so that when viewed by a camera, the clapper 10 is located at the bottom of the clapperboard 1, below the slate 20. When this occurs, the tilt sensor 53 outputs a signal representing that the clapperboard 1 is orientated upside down, causing the first and second display areas 23, 24 and the rear display area 30 to invert the information displayed on each display. This represents an inverted mode. This ensures that at all times information on the front 6 of the clapperboard 1 remains displayed in an upright orientation with respect to the camera and the information on the rear 7 of the clapperboard 1 remains displayed in an upright orientation with respect to the operator holding the clapperboard 1 and can therefore be easily read. In addition, if the at least one label 22 includes an electronic label, then the information displayed by that electronic label may also be inverted in response to the output of the tilt sensor 53, to correspond to the first and second display areas 23, 24. Similarly, the information displayed on the rear electronic display area 30 may also be inverted in response to the output of the tilt sensor 53. It is apparent that this capability could be applied to any electronic display area incorporated in the clapperboard 1.

Embodiments of the clapperboard 1 may also include one or more power-saving operations. According to one example, the clapperboard 1 is configured to operate in a particular power-saving operation based on the orientation of the clapperboard 1. The power-saving operation is determined based on a signal output from the tilt sensor 53.

When the tilt sensor 53 outputs a signal representing that the clapperboard 1 is placed face down on a surface (i.e. on its front, so that the front surface 6 is facing down), the microcontroller 50 turns off all of the components on the front 6 of the slate 20. In other words, the first and second electronic display areas 23, 24, the individual LEDs 25 and the light sensor 26 on the front 6 of the slate 20 are turned off. When the clapperboard 1 is placed on its front, the rear display area 30 remains active to enable the settings to be changed. This represents a first standby mode.

When the tilt sensor 53 outputs a signal representing that the clapperboard 1 is placed back-down on a surface (i.e. on its back or rear surface, so that the rear surface 7 is facing down), the microcontroller 50 turns off all of the electronic display areas on the clapperboard 1. In other words, the first and second electronic display areas 23,24, the individual LEDs 25 and the light sensor 26 on the front 6 of the slate 20 and the rear electronic display area 30 are turned off. This represents a second standby mode.

Both of the first (face-down) and second (back-down) standby modes reduce power consumption by turning of some or all of the external display components of the clapperboard 1.

When the tilt sensor 53 outputs a signal representing that the clapperboard 1 is upright, the microcontroller 50 turns on all of the displays. This orientation is associated with the normal operation of the clapperboard 1 when a shot is ready to start in the filming process. In other words, the clapperboard 1 is orientated so that when it is viewed by a camera, the clapper 10 is located at the top of the clapperboard 1, above the slate 20. This represents an active mode or full power mode.

The clapperboard can also be configured to operate according to an automatic standby mode. In the automatic standby mode the clapperboard 1 is configured to automatically enter the second standby mode after a predetermined period of time has passed. The predetermined period of time may start after the upper clapstick 12 has been raised and released at the start of a shot.

In film production, the timecode provides a precise means of synchronising time across devices used on a film shoot by use of a sequence of numeric codes generated at regular intervals. The timecode is handled via a master device, which generates the timecode against which all other devices (slave devices) are synchronised. At the master device the timecode is typically set to the time of day, but could equally well be set to whatever value is required. The timecode is, for instance, an LTC SMTPE time. The “user bits” are also set at the master device and can optionally be used by the slave devices. The user bits consist of four pairs of hexadecimal characters which enable metadata to be added to the timecode. The master device can be any device which handles the timecode. For instance, the master device may be an audio recorder, a camera or a dedicated external timecode generator. The process by which the slave devices are synchronised with the master device is known as “jamming”. After initial synchronisation, any of the slave devices that have been synchronised with the master device can subsequently act as a master device to synchronise other slave devices.

In accordance with one embodiment, in order to set the timecode for use in the filming process, the clapperboard 1 is connected to an external master device for jamming. The clapperboard 1 may connect to the master device by any suitable means. For instance, the clapperboard 1 connects to the master device via the BNC connector 45. The microcontroller 50 sets the timecode of the clapperboard 1 to be synchronised with that of the master device. Once, the timecode of the clapperboard 1 is set, the external master device is disconnected and the clapperboard 1 can maintain synchronicity with the master device.

Alternatively, according to another embodiment, the clapperboard 1 acts as the master device. The timecode unit 56 of the clapperboard 1 includes a timecode generator (as discussed above) that allows other external slave devices to be synchronised or “jammed” with the clapperboard 1. The external slave device may include a camera, an audio recorder, or the like.

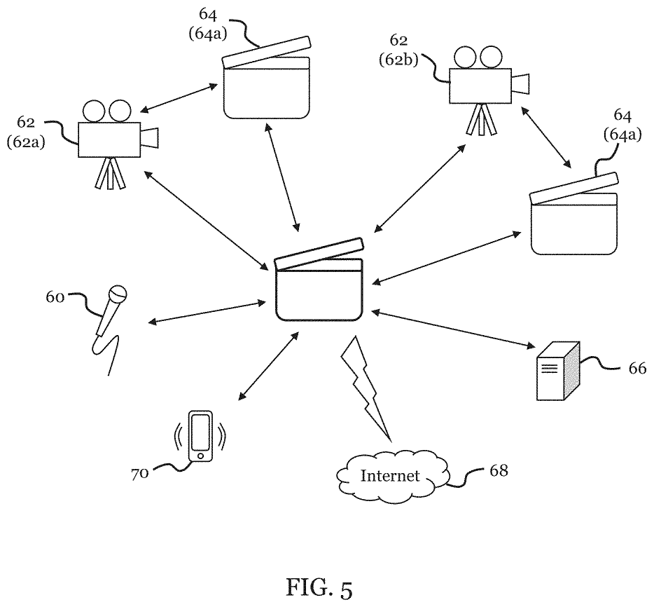

FIG. 5 shows embodiments in which the clapperboard 1, via the communication unit 55, establishes a wireless and/or wired connection to another device to transmit and/or receive data to/from the other device. The device may be an external device such as on-set devices associated with the filming process, including audio recorders 60, cameras 62 (62a, 62b . . . 62n), other clapperboards 64 (64a, 64b . . . 64n), and the like. The device may further include the Internet 68, a server 66, a mobile device 70, or the like. In this way the clapperboard 1 is configured to operate in a network (a networked environment of devices). The number, type and configuration of connections established by the clapperboard 1 can be set up and controlled through the rear display area 30. The data received and/or transmitted can be displayed, selected, edited and stored via the rear display area 30. Various (non-exhaustive) examples of these connections are described below.

In some embodiments, the clapperboard 1 has a wireless connection to other clapperboards 64 (64a, 64b . . . 64n) in use on the set. For instance, when more than one camera 62 is on set and it is not possible for each camera 62 to view the front 6 of the clapperboard 1 due to different camera orientation angles, an additional clapperboard 64a, 64b may be allocated to each camera 62a, 62b. In this instance, the clapperboard 1 synchronises the data between the clapperboards 64. The clapperboard 1 synchronise data such as scene, shot, take and audio file number between the other clapperboards 64 on set. Where data are specific to a particular camera 62, such as roll, filter and lens, synchronisation of those data is prevented so that the camera specific data are not overwritten on the clapperboard 64 linked to that camera 62. The clapperboard 1 may also act as a master device to synchronise timecode between other clapperboards 64 on set.

In some embodiments, the clapperboard 1 establishes a wireless connection to cameras 62 being used in the filming process. The clapperboard 1 connects to cameras 62, for instance, to augment camera metadata with data from the clapperboard 1. The clapperboard 1 can transmit data, such as scene, shot, take, and the quality of the take, for inclusion in the camera metadata. This removes the need to populate this information manually before editing in the post-production process. Instead, these data can be used in combination with camera metadata during editing to easily find the best clip in the editing software. The transfer of data recorded at the clapperboard 1 in advance thereby saves time and labour in the subsequent editing process.

In some embodiments, the clapperboard 1 also receives data from cameras 62. These data may include information such as the recording status of the camera 62. The data received can be read, stored and displayed on the clapperboard 1. The clapperboard 1 can show, for example, when the camera 62 is rolling. In addition, the clapperboard 1 may receive a wireless video feed from the camera 62 that it is directed towards at the start of a shot. The clapperboard 1 displays the video feed on the rear display area 30. The video feed is automatically flipped horizontally. The video feed enables the operator to see if the clapperboard 1 is in the shot and if the clapperboard 1 is not in the shot, the video feed allows the operator to move the clapperboard 1 to ensure that it is in the field of view of the camera 62 at the start of the shot. This ensures that the whole clapperboard 1 is recorded by the camera 62 at the start of the shot. It is necessary for the clapperboard 1 to be seen in full in order for the camera to record all of the information shown on the front 6 of the clapperboard 1 for use in post-production shot identification, as well as synchronisation of picture and sound.

In some embodiments, the clapperboard 1 establishes a wireless connection to an audio recorder 6o located on set. The clapperboard 1 transmits data including the scene, shot and take, for instance. A device external to the audio recorder 6o, but connected to an audio input, produces an audio signal of the transmitted data, in other words an audio output of the scene, shot and take.

In some embodiments, the clapperboard 1 establishes a wireless connection with a website via the Internet 68. This may be established directly via WiFi, 3G, GPRS, or the like capabilities of the communication unit 55 or via an external device through a server 66, a mobile device 70, or the like. The clapperboard 1 integrates with a website, in particular a website for film production management. The clapperboard 1 connects to a website to receive data from and/or transmit data to the website. The clapperboard 1 may be configured based on the information received from the website. For instance, the website hosts information relating to film productions, in particular the film currently in production. The information includes, for instance, information relating to the shooting schedule for each day, including the director, the camera person, the shooting order or Shot List, and the like. The clapperboard 1 is then able to receive or download from the website information relating to the day's shooting schedule. For instance, the clapperboard 1 receives from the website the Shot List for a chosen film production for that day.

In addition, the clapperboard 1 transmits data for upload to the website. For instance, the clapperboard 1 transmits the day's data log to the website. The data may include any information that the clapperboard is displaying, such as scene, shot, take, timecode at the point of clapping, audio file number, MOS, which cameras were used on each shot and what filters they were using, interior/exterior, day/night, and rating (e.g. a default rating for the take). The clapperboard 1 may transmit data to the website when the upper clapstick 12 contacts the lower clapstick 13 at the point of clapping at the start of each shot. At the point of clapping, the data may include a default rating for the take. Alternatively or in addition, the clapperboard 1 may transmit data to the website in response to an input from the operator. For instance, once a take has finished the operator may select a rating for that take and then transmit the data, including the selected rating. Alternatively or in addition, the clapperboard 1 may transmit data to the website in response to an input to turn off the clapperboard 1, but before power to the clapperboard 1 is turned off. Data uploaded to the website from the clapperboard 1 can then be download for use in editing software for post-production processing.

Alternatively, the data stored on the removable memory in the clapperboard 1 is removed and coupled to a computer or a mobile device 70 to transfer the data. The data stored on the removable storage can be uploaded to and used in editing software for post-production processing.

In some embodiments, the clapperboard 1 establishes a wireless connection to a mobile device 70. The mobile device 70 may be a mobile phone, such as a smartphone, a PDA, a laptop or tablet computer of any kind. The clapperboard 1 connects to the mobile device 70 via Bluetooth, for instance. The mobile device 70 is programmed in a suitable way, for instance by being provided with a software application for film production. The software application for film production is a distinct application. The software application may be provided on manufacture or it may be downloadable, for instance from an application marketplace or store. The mobile device 70, through the application may allow the operator to control the clapperboard 1. The application, when executed by the mobile device 70, causes the mobile device 70 to transmit and/or receive data to/from the clapperboard 1 and/or to control the clapperboard 1. For instance, the mobile device 70 may change settings of the clapperboard 1.

Accordingly, FIG. 5 shows embodiments in which the clapperboard 1, via the communication unit 55, connects to or pairs with one or more external devices and/or connects to an existing wireless network connected to the Internet 68. The external devices may represent multiple networked devices connected to the Internet, for instance, via a wireless network. The clapperboard 1, via the communication unit 55, communicates over at least one of a WiFi network, a Bluetooth network and a near-field communication network. The clapperboard 1, via the communication unit 55, is able to connect to and to transmit and/or receive information to/from at least one networked device.

Accordingly, FIG. 5 shows embodiments of a system including an electronic clapperboard 1 as described hereinabove and an external device, and that the electronic clapperboard is configured to connect to and transmit and/or receive data to/from the external device wirelessly.

Various alternatives and modifications to the embodiments shown and described above will be apparent to those skilled in the art. For instance, it will be evident that compatible features (one or more) of different embodiments may be combined. Some such variations and modifications will now be described.

The figures show components of the clapperboard 1 provided in a particular arrangement on the front 6 and back of the slate 20. However, the invention is not limited to such an arrangement and the location, shape and number of each of the various manual/electronic display areas, individual LEDs 25, the light sensor 26 and the operation panels 31 may equally well be modified or adapted as required.

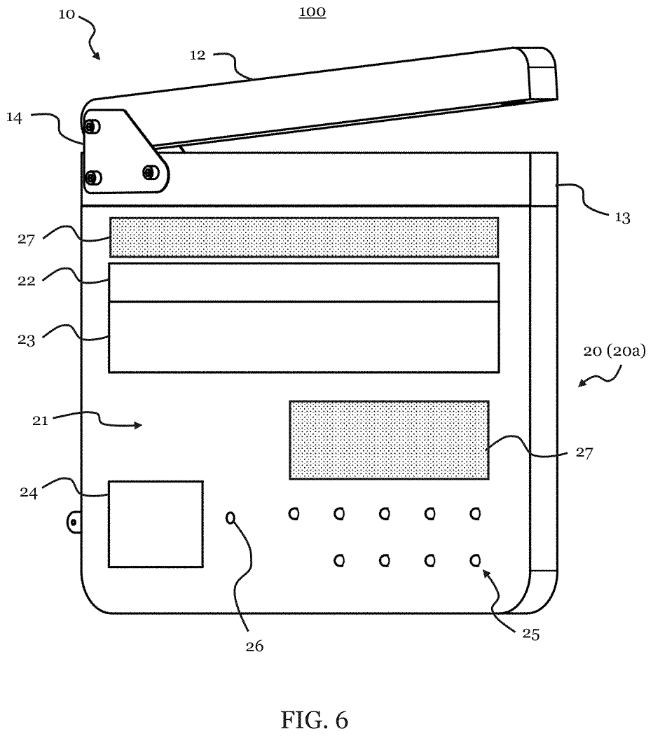

The first display area 23 has been described as an LED matrix display, the second display area 24 has been described as an OLED display, and the rear display area 30 has been described as an LCD display. However, the invention is not limited to such a configuration and the display may be of any suitable kind to display the required information. For instance, the rear display area 30 could be an OLED display or all of the displays may be the same type of display as each other. In addition, one or more of the electronic (or manual) display areas (on the front 6 or rear 7 of the slate) may be replaced with an ePaper display, such as an eInk display. Alternatively or in addition, an eInk display may be used for information that does not change often during film production, such as the production, director and camera. FIG. 6 shows an example embodiment loo in which portions of the manual display area 21 are replaced with an eInk display 27.

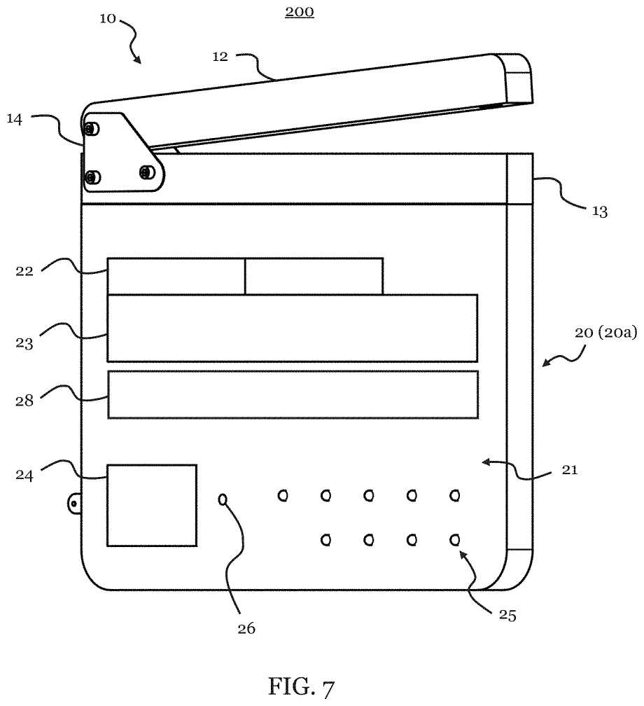

The first display area 23 has been described as having two different display configurations or formats, but additional formats could equally well be implemented. In addition, although one first display area 23 has been described, two LED matrix displays could equally well be implemented. FIG. 7 shows an exemplary embodiment 200 of in which one matrix display 23 is dedicated to scene, shot, roll and take and the other matrix display 28 is dedicated to timecode.

Although the at least one label 22 has been shown as one label, it will be understood that various different combinations may equally well be implemented. For instance, the at least one label 22 is two labels, including one OLED display and one detachable element. Alternatively or additionally, the at least one label 22 may include an eInk display. In the exemplary embodiment 200 shown in FIG. 7, the at least one label 22 is three labels including two OLED displays and one manual display area. Various other combinations may equally well be implemented. In addition, any label referred to herein may equally well be considered as a heading, a designation, a marker, or a tag.

Although two operation panels 31 are described, this is not essential and the rear surface 7 may equally well include one operation panel or three or more operation panels. Although the operation panels 31 are described as being recessed in the rear surface 7 of the slate body 20a, this is not essential and an alternative configuration could equally well be implemented.

Various buttons are described as being employed in the operation panels 31, however the invention is not limited to this and rotary encoders could be used to increase and decrease values instead of buttons. Alternatively, a multi-function touch-sensitive input transducer or a multi-function mechanical input transducer may equally well be provided in order to confirm something and/or to trigger actions and to simplify the configuration of the clapperboard 1.

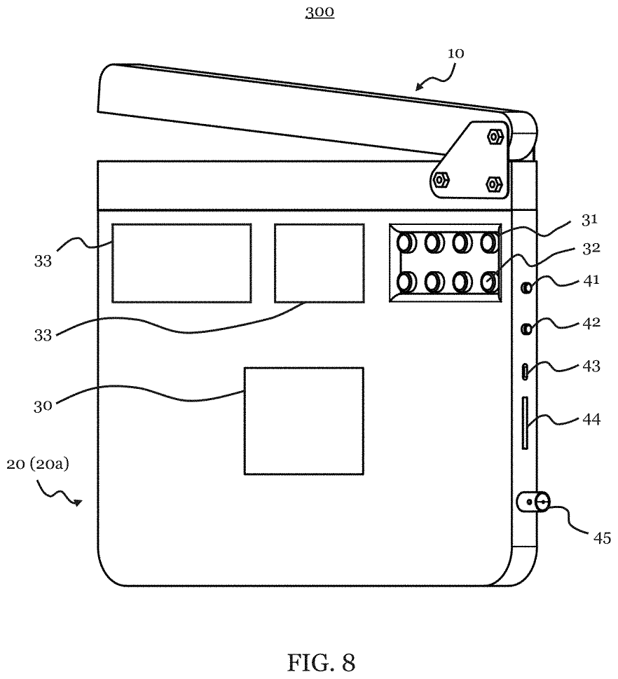

In addition, one or more of the operation panels 31 may equally well be configured as an electronic display in the form of a touchscreen having electronic buttons to perform the functions as described above. FIG. 8 shows an embodiment 300 in which three operation panels are provided on the rear surface 7 of the slate 20 and arranged so that one of the operation panels 31 includes a plurality of mechanical buttons 32 and two of the operation panels 33 are configured as electronic displays including a touchscreen.

Furthermore, in addition to or instead of the operation panels 31, the rear 7 of the clapperboard 1 may include an individual button. The button may be configured to toggle the first display area 23 between the first and second configurations. The button may be located on the clapperboard 1, for instance, in a position that the operator can easily reach with a thumb or finger when holding the clapperboard 1. For instance, the button may be located on the clapper 10, for example, on the top surface of the upper clapstick 12.

The plurality of individual light sources 25 have been described as LEDs, however any other suitable light sources may be used. Suitable light sources might include light bulbs, laser diodes and organic LEDs. Similarly, although the individual LEDs 25 have been described as being green LEDs, other colours or white light may also be used. In addition, whilst nine LEDs have been shown, in other embodiments other numbers of light sources may be included. The choice of the number of light sources may depend on the information requirements of the clapperboard 1.

A tilt sensor 53 has been described to implement a power-saving operation of the clapperboard 1. However, the clapper 10 may also be configured to control a power-saving operation of the clapperboard 1. For instance, raising the upper clapstick 12 (second position to first position) may cause the clapperboard 1 to transition from a standby mode to an active mode. The movement of the upper clapstick 12 from the first position to the second position may also cause the clapperboard 1, after a predetermined period of time, to enter a standby mode.

A BNC connector 45 has been described as means to set the timecode of the clapperboard 1 (perform jamming), but this could equally well be achieved via another form of connector. For instance, a 3.5 mm audio jack or a balanced XLR could equally well be implemented. Alternatively, the clapperboard 1 establishes a wireless connection, through the communication unit 55, with a master device (external device) to receive and synchronise timecode, as described above.

The battery has been described as a rechargeable battery, but the invention is not limited to this and the battery could equally well be a user-replaceable battery of any suitable kind.

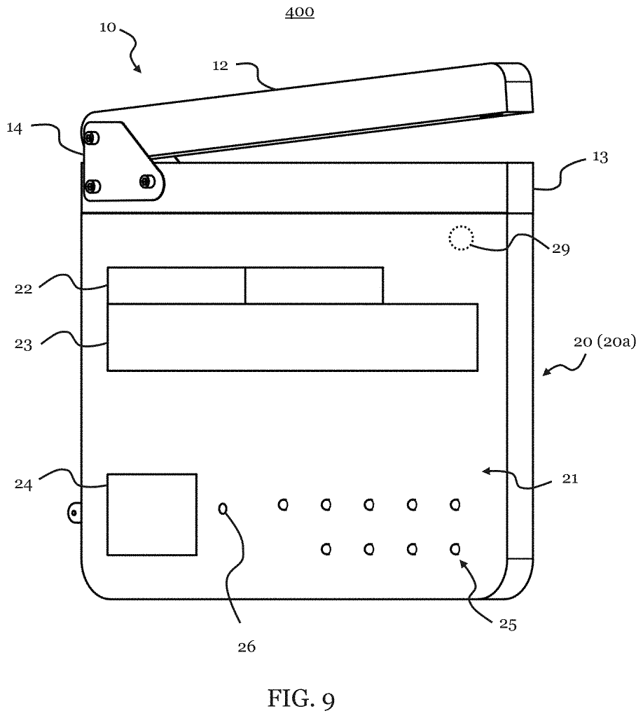

Various components have been described as being provided on the front and rear of the clapperboard, however one or more of these components may equally well be omitted or located at a different position on the clapperboard 1 and/or additional components may also be provided. For instance, FIG. 9 shows an example embodiment 400 in which the clapperboard includes an acoustic signal generator 29 provided on the front 6 of the slate 20. The acoustic signal generator 29 may be any suitable type of electric acoustic signal generator capable of emitting an audio signal. The acoustic signal generator 29 is, for instance, a speaker. The speaker outputs a synthesised or pre-recorded audio signal providing, for instance, the relevant scene, shot and/or take. The speaker may output the audio signal in response to an input from the operator. For instance, when the operator presses a button 32 of the operation panels 31 on the rear 7 of the clapperboard, the acoustic signal generator 29 outputs an audio signal. One or more acoustic signal generators 29 may be provided.

In addition to or instead of an acoustic signal generator, one or more acoustic sensors could be provided. The number and arrangement of these components may be selected according to the requirements of the operator. The one or more acoustic sensors may be any suitable device for detecting sound. The acoustic sensor is, for instance, a microphone, such as a moving coil or dynamic microphone, a condenser microphone or a piezoelectric microphone. For instance, the microphone may be configured to detect and record acoustic signals when a button on the clapperboard 1 is pressed. The microphone may be located on the front 6 of the clapperboard 1, for instance, but other positions would also be suitable.

Various components have been described as being provided on the side of the clapperboard 1, however one or more of these components may equally well be omitted or located at a different position on the clapperboard 1 and/or additional components may also be provided. For instance, the slate body 20a could be configured to store a manual writing implement for the manual display area or an ePen for an electronic display area. The ePen could be housed at the bottom or the side of the slate 20, for instance. In addition or alternatively, another audio input and/or audio output could be provided via either a 3.5 mm or balanced XLR connector.

Although the invention has been shown and described according to the above embodiments, it would be appreciated by those skilled in the art that changes may be made to the subject matter described herein without departing from the present invention, the scope of which is defined in the claims.

1. An electronic clapperboard comprising a clapper and a slate,
wherein the clapper is disposed at a top of the slate and comprises an elongate member pivotally attached to the slate, and
the slate defines a housing and comprises:
a manual display area and a plurality of electronic display areas disposed on a front surface, and
an electronic rear display area disposed on a rear surface.

2. The electronic clapperboard according to claim 1, wherein the plurality of electronic display areas disposed on the front surface comprises a first display area,
wherein the first display area is configured to toggle or switch between two different display configurations, each configured to display information relating to film production.

3. The electronic clapperboard according to claim 1, wherein the plurality of electronic display areas disposed on the front surface comprises a second display area,
wherein the second display area is configured to display information relating to film production.

4. The electronic clapperboard according to claim 1, further comprising one or more individual LEDs disposed on the front surface of the slate.

5. The electronic clapperboard according to claim 4, wherein each of the one or more individual LEDs corresponds to a setting, and
wherein the setting includes one or more of Night, Day, Interior, Exterior, MOS, Camera A, Camera B, VFX, and Sync.

6. The electronic clapperboard according to claim 2, further comprising at least one label disposed on the front surface of the slate, and
wherein the at least one label is configured to display one or more headings corresponding to information displayed in the first display area.

7. (canceled)

8. The electronic clapperboard according to claim 1, further comprising a light level sensor disposed on the front surface of the slate.

9. The electronic clapperboard according to claim 1, wherein the electronic rear display area is an LCD display and at least part of the LCD display comprises a touchscreen, wherein the electronic rear display area is configured to control an operation of at least one of the plurality of electronic display areas.

10. The electronic clapperboard according to claim 1, further comprising an operation panel disposed on the rear surface of the slate, and including a plurality of input transducers, wherein the operation panel is configured to control an operation of at least one of the plurality of electronic display areas.

11. (canceled)

12. The electronic clapperboard according to claim 1, wherein the elongate member comprises a lower member coupled to the slate and an upper member pivotally coupled to the lower member,
wherein the upper member is movable between a first configuration in which a bottom surface of the upper member is spaced apart from the lower member and a second configuration in which the bottom surface of the upper member is disposed adjacent to the top surface of the lower member, and
wherein the elongate member includes a sensor configured to sense when the upper member moves between the first configuration to the second configuration.

13. The electronic clapperboard according to claim 12,
wherein when the upper member moves from the second configuration to the first configuration, a value displayed on one or more of the plurality of electronic display areas and/or the rear display area is automatically incremented by one, and/or
when the upper member moves from the first configuration to the second configuration, a record of values is stored in a memory of the clapperboard.

14. The electronic clapperboard according to claim 1, further comprising a timecode unit including:
a timecode generator configured to generate timecode; and
a timecode decoder, configured to receive and decode timecode from a master device and synchronise the timecode of the clapperboard with the master device.

15. The electronic clapperboard according to claim 1, further comprising a tilt sensor configured to detect an orientation of the clapperboard.

16. (canceled)

17. The electronic clapperboard according to claim 15, wherein when the tilt sensor detects that the clapperboard is orientated upside-down, the tilt sensor is configured to output a signal representing an inverted mode in which the plurality of electronic display areas is configured to invert information displayed on each display.

18. The electronic clapperboard according to claim 1, further comprising a communication unit configured to connect to and transmit and receive information to/from an external device wirelessly, wherein the communication unit is configured to communicate over at least one of a WiFi network, a Bluetooth network, a near-field communication network, and an ISM band.

19. (canceled)

20. The electronic clapperboard according to claim 18, wherein the communication unit is configured to:
connect to an on-set camera; and
transmit data stored in a memory at the clapperboard to an on-set camera to be included in metadata of the on-set camera; and/or
the communication unit is configured to:
receive data from the camera; and
store the received data in a memory.

21. The electronic clapperboard according to claim 18, wherein the communication unit is configured to connect to a mobile device, the mobile device including computer code that when executed by the mobile device causes the mobile device to transmit data to and/or receive data from the clapperboard.

22. (canceled)

23. The electronic clapperboard according to claim 20, wherein the communication unit is configured to transmit data stored at the clapperboard to a web site.

24. The electronic clapperboard according to claim 23, wherein the communication unit is configured to transmit data stored at the clapperboard to the web site when the elongate member of the clapper moves from a first configuration to a second configuration.

25. (canceled)

26. The electronic clapperboard according to claim 14, wherein the timecode generator is further configured to transmit a timecode to an external device to synchronise the timecode of the external device with the timecode of the clapperboard.
